(19) United States
(12) Patent Application Publication
(10) Pub. No.: US 2006/0122413 A1
(43) Pub. Date: Jun. 8, 2006

(54) Aminomethylene functional siloxanes

(76) Inventors: Oliver Schafer, Burghausen (DE); Andreas Bauer, Simbach (DE); Andrea Kneissl, Ottobrunn (DE)

Correspondence Address: BROOKS KUSHMAN P.C., 1000 TOWN CENTER, TWENTY-SECOND FLOOR, SOUTHFIELD, MI, 48075, US

(21) Appl. No.: 10/543,291

(22) PCT Filed: Dec. 18, 2003
(86) PCT No.: PCT/EP03/14488

§ 371 Date: Jul. 25, 2005

(30) Foreign Application Priority Data
Jan. 30, 2003 (DE) 103 03 693.8

(51) Int. Cl. C07F 7/04

(52) U.S. Cl. 556/413

(57) ABSTRACT

Organopolysiloxanes containing pendent silicon-bonded aminomethylene groups may be prepared by reaction of hydroxy-functional siloxanes or polysiloxanes with aminomethylalkoxysilanes. By adjusting the functionalities of the siloxane and silane, branched siloxanes with aminomethylene functionality may be obtained, as may also organopolysiloxanes of high amine number, reflecting numerous chain-pendent aminomethylene groups. The products are easily emulsifyable in water.

The invention relates to aminomethylene-functional siloxanes and to a process for their preparation using alkoxysilanes.

Aminoalkylpolysiloxanes in which the amino groups are pendent on the siloxane chain can be used in many fields of application, for example as softeners for textiles or textile fabrics, for example cotton.

For example, the base-catalyzed equilibration of octamethylcyclotetrasiloxane with alkoxy-functional aminopropylsilanes or aminoethylaminopropylsilanes is known. This reaction has the disadvantage that long reaction times are needed for this purpose, and the equilibration conditions result in residual contents of D4 cycles remaining in the product, which subsequently have to be removed by distillation.

A further process for preparing such polysiloxanes consists in preparing them by cohydrolyzing difunctional silanes with organofunctional aminosilanes. However, this has the disadvantage that the cohydrolysis, owing to the presence of amino groups, cannot be carried out with chlorosilanes, and alkoxysilanes have to be used instead. This means that the hydrolysis first has to be preceded by the esterification of the chlorosilanes which, in the subsequent hydrolysis, results in the valuable alcohol being lost. In addition, this process has the disadvantage that catalysts have to be used and cycle formation is likewise observed.

DE-A-2500020 and DE 1244181 describe a process for preparing terminal aminomethylsiloxanes. In this process, OH-terminated siloxanes are reacted with secondary aminomethylsilanes with elimination of alcohol. The advantage of this process is a reaction of a siloxane with an alkoxysilane without at the same time equilibrating the reaction mixture, which would lead to the formation of siloxane cycles as a by-product and is therefore not wanted. However, the thus prepared siloxanes, owing to the terminal amino group, can be obtained only with a defined amine number at a given molecular weight or viscosity. It is also difficult to emulsify these materials in water, which is virtually prohibitive for the applications of these compounds in aqueous systems, as is customary, for example, in the textile field. Materials which, at a given molecular weight, can have a different amine number, which is significant, inter alia, for the binding to fibers or textile fabrics, can be obtained only by the use of pendent amino groups, the amino groups in the side group greatly easing emulsification in water.

It is therefore an object of the invention to provide pendent, amino-functional siloxanes in a simple manner, which can have a variable number of amino groups at a given molecular weight.

The invention provides amino-functional organosiloxanes of the general formula I
(SiO_{4/2})ₖ(RSiO_{3/2})ₘ(R₂SiO_{2/2})ₚ(R₃SiO_{1/2})_{q}[O_{1/2}H]ₜ[(O_{f/2}R¹_{3-f}SiCR²₂)_{3-g}NR_{g}⁴]ₛ (I)
in which
R is a hydrogen atom or a monovalent Si—C-bonded C₁-C₂₀-hydrocarbon radical or C₁-C₁₅-hydrocarbonoxy radical, each of which is optionally substituted by —CN, —NCO, —NR^{x}₂, —COOH, —COOR^{x}, -halogen, -acryloyl, -epoxy, —SH, —OH or —CONR^{x}₂, and in each of which one or more non-adjacent methylene units may be replaced by —O—, —CO—, —COO—, —OCO— or —OCOO—, —S— or —NR^{x}— groups, and in each of which one or more non-adjacent methine units may be replaced by —N═, —N═N— or —P═ groups,
R¹ is a hydrogen atom or a monovalent Si—C-bonded C₁-C₂₀-hydrocarbon radical or C₁-C₁₅-hydrocarboxy radical which is optionally substituted by —CN, —NCO, —COOH, —COOR^{x}, -halogen, -acryloyl, —SH, —OH or —CONR^{x}₂, and in each of which one or more non-adjacent methylene units may be replaced by —O—, —CO—, —COO—, —OCO— or —OCOO—, —S— or —NR^{x}— groups, and in each of which one or more non-adjacent methine units may be replaced by —N═, —N═N— or —P═ groups,
R^{x} is a hydrogen or a C₁-C₁₀-hydrocarbon radical which is optionally substituted by —CN or halogen,
R² is a hydrogen or a C₁-C₂₀-hydrocarbon radical which is optionally substituted by —CN or halogen,
R⁴ is a hydrogen or a C₁-C₂₀-hydrocarbon radical which is optionally substituted by —CN or halogen,
k, m, p, q are each independently an integer from at least 0 to 100 000,
f is an integer of 1, 2 or 3,
g is an integer of 0, 1 or 2,
s is an integer of at least 1 and
t is an integer of at least 0, where
k+m+p+q is an integer of at least 1.

The amino-functional organosiloxanes of the general formula I have an amino function which is bonded by a carbon atom to a silicon atom of the siloxane chain. At least one amino function is preferably positioned in the chain, but terminal amino groups may also optionally be present. The amino functions are very reactive. For example, crosslinked epoxy resins may therefore be prepared with the amino-functional siloxanes by reaction with epoxy-functional compounds.

R may be aliphatically saturated or unsaturated, aromatic, straight-chain or branched. R is preferably a C₁-C₁₀-alkyl radical or phenyl radical, in particular unbranched C₁-C₃-alkyl radical, which may be substituted. R is more preferably a methyl radical.

The C₁-C₂₀-hydrocarbon radicals R¹ may be aliphatically saturated or unsaturated, aromatic, straight-chain or branched. R¹ preferably has from 1 to 12 atoms, in particular from 1 to 6 atoms, preferably only carbon and hydrogen atoms.

R¹ is preferably a straight-chain or branched C₁-C₆-alkyl radical. The radicals are more preferably methyl, ethyl, phenyl, vinyl and trifluoropropyl.

The R² radicals may each independently likewise be aliphatically saturated or unsaturated, aromatic, straight-chain or branched. R² is preferably a C₁-C₃-alkyl radical or hydrogen. R² is more preferably hydrogen.

The R⁴ radicals may each independently likewise be aliphatically saturated or unsaturated, aromatic, cyclic, straight-chain or branched. R⁴ is preferably a C₁-C₁₂-alkyl or aryl radical or hydrogen. R⁴ is more preferably hydrogen, methyl, butyl, phenyl or cyclohexyl. R⁴ may optionally also contain heteroatoms, for example oxygen or nitrogen, or other functional groups.

The R^{x} radicals are preferably hydrogen or a substituted C₁-C₅-alkyl radical.

p is preferably from 3 to 1000, in particular from 5 to 500.

k and m are preferably each independently an integer from at least 0 to 1000, in particular 0.

q is preferably an integer of at least 1.

k+m is preferably 0, i.e. the amino-functional organosiloxanes are linear. q is preferably 1 or 2.

s is preferably from 1 to 50, in particular from 2 to 10.

g is preferably less than or equal to f.

t is preferably from 0 to 10, in particular 0, 1 or 2.

k+m+p+q is preferably an integer of at least 2, in particular at least 3.

The invention also provides a process for preparing the amino-functional organosiloxanes of the general formula I, in which siloxanes of the general formula (II)
(SiO_{4/2})ₖ(RSiO_{3/2})ₘ(R₂SiO_{2/2})ₚ(R₃SiO_{1/2})_{q}[O_{1/2}H]ᵣ (II)
are reacted with amino-functional silanes of the formula (III)
[(R³O)_{f}R¹_{3-f}SiCR²₂]_{3-g}NR_{g9}⁴ (III)
where
R³ is hydrogen or a C₁-C₂₀-hydrocarbon radical which is optionally substituted by —CN or halogen,
r is an integer of at least 1 and
t is less than r and
R, R¹, R², R⁴, k, m, p, q, f, g and s are each as defined above.

The R³ radicals may each independently likewise be aliphatically saturated or unsaturated, aromatic, straight-chain or branched. R³ is preferably a C₁-C₅-alkyl radical, in particular C₁-C₃-alkyl radical, or hydrogen. R³ is more preferably methyl or ethyl.

To prepare linear amino-functional organosiloxane of the general formula I, preference is given to using organosiloxane of the general formula II in which r is 1 or 2.

The alkoxysilanes of the general formula III used may be prepared in a simple manner and in high yields by aminating the corresponding chloroalkyl(alkoxy)silanes, as described, for example, in SU 395371.

Examples of alkoxysilanes of the general formula III are:
H₃COSi(CH₃)₂CH₂NH₂, (H₃CO)₂Si(CH₃)CH₂NH₂, (H₃CO)₃SiCH₂NH₂, H₅C₂OSi(CH₃)₂CH₂NH₂, (H₅C₂O)₂Si (CH₃)CH₂NH₂, (H₅C₂O)₃SiCH₂NH₂, H₃COSi(CH₃)₂CH₂N(C₄H₉)₂, (H₃CO)₂Si(CH₃)CH₂N(C₄H₉)₂, (H₃CO)₃SiCH₂N(C₄H₉)₂, H₅C₂OSi (CH₃)₂CH₂N(C₄H₉)₂, (H₅C₂O)₂Si(CH₃)CH₂N(C₄H₉)₂, (H₅C₂O)₃SiCH₂N(C₄H₉)₂, H₃COSi (CH₃)₂CH₂NH(C₆H₅), (H₃CO)₂Si (CH₃) CH₂NH(C₆H₅), (H₃CO)₃SiCH₂NH(C₆H₅), H₅C₂OSi (CH₃)₂CH₂NH(C₆H₅), (H₅C₂O)₂Si(CH₃)CH₂NH(C₆H₅), (H₅C₂O)₃SiCH₂NH(C₆H₅), H₃COSi(CH₃)₂CH₂NH(C₆H₁₁), (H₃CO)₂Si(CH₃) CH₂NH(C₆H₁₁), (H₃CO)₃SiCH₂NH(C₆H₁₁), H₅C₂OSi(CH₃)₂CH₂NH(C₆H₁₁), (H₅C₂O)₂SiCH₃)CH₂NH(C₆H₁₁), (H₅C₂O)₃SiCH₂NH(C₆H₁₁), (H₃COSi(CH₃)₂CH₂)₂NH, (H₃COSi(CH₃)₂CH₂)₃N, (H₅C₂OSi(CH₃)₂CH₂)₂NH, (HSC₂OSi (CH₃)₂CH₂)₃N, ((H₃CO)₂Si(CH₃)CH₂)₂NH, ((H₃CO)₂Si(CH₃)CH₂)₃N, ((H₃CO)₃SiCH₂)₂NH, ((H₃CO)₃SiCH₂)₃N, and many others.

The alkoxysilanes of the general formula III react readily and very rapidly with hydroxy-functional siloxanes of the general formula II. It is possible to dispense with the use of specific catalysts. The reaction proceeds autocatalytically. However, it is possible to use other catalysts if required.

In order to enable a reaction between the organosiloxane of the general formula II and the alkoxysilane of the general formula III, the organosiloxane of the general formula II has to contain hydroxyl groups. The reaction proceeds with elimination of the alcohol R³OH.

As appropriate, this can remain in the product after the reaction or else be removed.

In the process for preparing amino-functional organosiloxane of the general formula I, the amount of the alkoxysilanes of the general formula III used depends upon the amount of the silanol groups to be functionalized. However, when the intention is to achieve full functionalization of the OH groups, the alkoxysilane has to be added in at least equivalent amounts.

If the alkoxysilane of the general formula III is added to the organosiloxane of the general formula II in deficiency, residual unconverted Si—OH groups may remain in the amino-functional organosiloxane of the general formula I or may be reacted with other compounds which react with Si—OH groups, so that a further reduction in the Si—OH content can be achieved and, for example, unreactive end groups can be introduced into the silicone oil mixture, which allows a restriction of the molecular weight to be achieved in later copolymerizations. In this case, an isolation of the intermediate is not always necessary. It is also possible to use organosiloxanes of the general formula II which already bear reactive groups, also including aminoalkyl groups.

Preference is given to carrying out the process at from 0° C. to 100° C., more preferably at from 10° C. to 40° C. The process may be carried out either with incorporation of solvents or else without the use of solvents, in suitable reactors. As appropriate, operation is affected under reduced pressure or under elevated pressure or at standard pressure (0.1 MPa). The alcohol which forms may then be removed from the reaction mixture under reduced pressure at room temperature or at elevated temperature.

When solvents are used, preference is given to inert, especially aprotic, solvents such as aliphatic hydrocarbons, for example heptane or decane, and aromatic hydrocarbons, for example toluene or xylene. It is likewise possible to use ethers such as THF, diethyl ether or MTBE. The amount of the solvent should be sufficient to ensure sufficient homogenization of the reaction mixture. Preference is given to solvents or solvent mixtures having a boiling point or boiling range of up to 120° C. at 0.1 MPa.

All of the above symbols of the above formulae are each defined independently of one another.

In the examples which follow, unless stated otherwise, all amounts and percentages are based on the weight, all pressures are 0.10 MPa (abs.) and all temperatures are 20° C.

Experiment 1:

In a 1-liter steel autoclave, 100 g of chloromethyldimethylmethoxysilane (Starfire Systems, Troy, USA) were reacted in an autoclave with 300 g of liquid ammonia at a temperature of 100° C. After 5 hours, the mixture was cooled to room temperature, the autoclave was decompressed to standard pressure and 500 ml of dry heptane were added. The precipitated ammonium chloride was filtered off, the heptane was removed by distillation and the product was purified by distillation. 56 g of aminomethyldimethylmethoxysilane were obtained.

Experiment 2:

In a 1-liter steel autoclave, 100 g of chloromethyltrimethoxysilane (Starfire Systems, Troy, USA) were reacted in an autoclave with 300 g of liquid ammonia at a temperature of 100° C. After 5 hours, the mixture was cooled to room temperature, the autoclave was decompressed to standard pressure and 500 ml of dry heptane were added. The precipitated ammonium chloride was filtered off, the heptane was removed by distillation and the product was purified by distillation. 56 g of aminomethyltrimethoxysilane were obtained.

Experiment 3:

In a 1-liter round-bottom flask, 100 g of chloromethyldimethylmethoxysilane (Starfire Systems, Troy, USA) were reacted with 300 g of cyclohexylamine at a temperature of 100° C. After 4 hours, the mixture was cooled to room temperature, the autoclave was decompressed to standard pressure and 500 ml of dry heptane were added. The precipitated cyclohexylammonium chloride was filtered off, the heptane was removed by distillation and the product was purified by distillation. 56 g of cyclohexylaminomethyldimethylmethoxysilane were obtained.

Experiment 4:

In a 1-liter round-bottom flask, 100 g of chloromethyltrimethoxysilane (Starfire Systems, Troy, USA) were reacted with 300 g of cyclohexylamine at a temperature of 100° C. After 4 hours, the mixture was cooled to room temperature, the autoclave was decompressed to standard pressure and 500 ml of dry heptane were added. The precipitated cyclohexylammonium chloride was filtered off, the heptane was removed by distillation and the product was purified by distillation. 56 g of cyclohexylaminomethyltrimethoxysilane were obtained.

Experiment 5:

In a 1-liter round-bottom flask, 100 g of 1-chloromethyl-1,1-dimethoxy-1-methylsilane (Starfire Systems, Troy, USA) were reacted with 300 g of cyclohexylamine at a temperature of 100° C. After 4 hours, the mixture was cooled to room temperature, the autoclave was decompressed to standard pressure and 500 ml of dry heptane were added. The precipitated cyclohexylammonium chloride was filtered off, the heptane was removed by distillation and the product was purified by distillation. 65 g of cyclohexylaminomethyldimethoxymethylsilane were obtained.

Experiment 6:

In a 1-liter steel autoclave, 100 g of chloromethyldimethoxymethylsilane (Starfire Systems, Troy, USA) were reacted in an autoclave with 300 g of liquid ammonia at a temperature of 100° C. After 5 hours, the mixture was cooled to room temperature, the autoclave was decompressed to standard pressure and 500 ml of dry heptane were added. The precipitated ammonium chloride was filtered off, the heptane was removed by distillation and the product was purified by distillation. 45 g of aminomethyldimethoxymethylsilane were obtained.

### EXAMPLE 1

1000 g of bishydroxy-terminated polydimethylsiloxane having an average molecular weight of 3000 g/mol were reacted at room temperature with 23 g of (1-aminomethyl)dimethoxymethylsilane. ¹H NMR and ²⁹Si NMR showed that, after 30 minutes, all alkoxy groups had been converted and an aminomethyl-functionalized polydimethylsiloxane with Si—OH end groups had been obtained. The methanol by-product was removed under reduced pressure and 1010 g of poly(aminomethylmethylsiloxane-co-dimethylsiloxane) having a viscosity of 140 mPas were obtained.

### EXAMPLE 2

1000 g of bishydroxy-terminated polydimethylsiloxane having an average molecular weight of 3000 g/mol were reacted at room temperature with 30 g of (1-aminomethyl)dimethoxymethylsilane. ¹H NMR and ²⁹Si NMR showed that, after 30 minutes, all alkoxy groups had been converted and an aminomethyl-functionalized polydimethylsiloxane with Si—OH end groups had been obtained. The methanol by-product was removed under reduced pressure and 1030 g of poly(aminomethylmethylsiloxane-co-dimethylsiloxane) having a viscosity of 1000 mPas were obtained.

### EXAMPLE 3

1000 g of bishydroxy-terminated polydimethylsiloxane having an average molecular weight of 3000 g/mol were reacted at room temperature with 22.5 g of (1-aminomethyl)dimethoxymethylsilane reacted and 39.8 g of (1-aminomethyl)dimethylmethoxysilane. ¹H NMR and ²⁹Si NMR showed that, after 30 minutes, all alkoxy groups had been converted and an aminomethyl-functionalized polydimethylsiloxane with aminomethyl end groups had been obtained. The methanol by-product was removed under reduced pressure and 1030 g of poly(aminomethylmethylsiloxane-co-dimethylsiloxane) having aminomethyl end groups and a viscosity of 100 mPas were obtained.

### EXAMPLE 4

1000 g of bishydroxy-terminated polydimethylsiloxane having an average molecular weight of 3000 g/mol were reacted at room temperature with 30 g of (1-aminomethyl)dimethoxymethylsilane reacted and 26.5 g of (1-aminomethyl)dimethylmethoxysilane. ¹H NMR and ²⁹Si NMR showed that, after 30 minutes, all alkoxy groups had been converted and an aminomethyl-functionalized polydimethylsiloxane with aminomethyl end groups had been obtained. The methanol by-product was removed under reduced pressure and 1030 g of poly(aminomethylmethylsiloxane-co-dimethylsiloxane) having aminomethyl end groups and a viscosity of 180 mPas were obtained.

### EXAMPLE 5

1000 g of bishydroxy-terminated polydimethylsiloxane having an average molecular weight of 3000 g/mol were reacted at room temperature with 33.8 g of (1-aminomethyl)dimethoxymethylsilane reacted and 19.9 g of (1-aminomethyl)dimethylmethoxysilane. ¹H NMR and ²⁹Si NMR showed that, after 30 minutes, all alkoxy groups had been converted and an aminomethyl-functionalized polydimethylsiloxane with aminomethyl end groups had been obtained. The methanol by-product was removed under reduced pressure and 1030 g of poly(aminomethylmethylsiloxane-co-dimethylsiloxane) having aminomethyl end groups and a viscosity of 290 mPas were obtained.

### EXAMPLE 6

1000 g of bishydroxy-terminated polydimethylsiloxane having an average molecular weight of 3000 g/mol were reacted at room temperature with 33.8 g of (1-aminomethyl)dimethoxymethylsilane reacted and 14.5 g of hexamethyldisilazane. ¹H NMR and ²⁹Si NMR showed that, after 20 hours, all alkoxy groups had been converted and an aminomethyl-functionalized polydimethylsiloxane with trimethylsilyl end groups had been obtained. The methanol by-product was removed under reduced pressure and 1030 g of poly(aminomethylmethylsiloxane-co-dimethylsiloxane) having aminomethyl end groups and a viscosity of 270 mPas were obtained.

### EXAMPLE 7

1000 g of bishydroxy-terminated polydimethylsiloxane having an average molecular weight of 3000 g/mol were reacted at room temperature with 36.2 g of (1-cyclohexylaminomethyl)dimethoxymethylsilane. ¹H NMR and ²⁹Si NMR showed that, after 60 minutes, all alkoxy groups had been converted and a cyclohexylaminomethyl-functionalized polydimethylsiloxane with Si—OH end groups had been obtained. The methanol by-product was removed under reduced pressure and 1030 g of poly(cyclohexylaminomethylmethylsiloxane-co-dimethylsiloxane) having a viscosity of 180 mPas were obtained.

### EXAMPLE 8

1000 g of bishydroxy-terminated polydimethylsiloxane having an average molecular weight of 10 000 g/mol were reacted at room temperature with 6.8 g of (1-aminomethyl)dimethoxymethylsilane. ¹H NMR and ²⁹Si NMR showed that, after 30 minutes, all alkoxy groups had been converted and an aminomethyl-functionalized polydimethylsiloxane with Si—OH end groups had been obtained. The methanol by-product was removed under reduced pressure and 980 g of poly(aminomethylmethylsiloxane-co-dimethylsiloxane) having a viscosity of 1800 mPas were obtained.

### EXAMPLE 9

1000 g of bishydroxy-terminated polydimethylsiloxane having an average molecular weight of 1000 g/mol were reacted at room temperature with 67.7 g of (1-aminomethyl)dimethoxymethylsilane. ¹H NMR and ²⁹Si NMR showed that, after 30 minutes, all alkoxy groups had been converted and an aminomethyl-functionalized polydimethylsiloxane with Si—OH end groups had been obtained. The methanol by-product was removed under reduced pressure and 1040 g of poly(aminomethylmethylsiloxane-co-dimethylsiloxane) having a viscosity of 62 mPas were obtained.

### EXAMPLE 10

1000 g of monohydroxy-terminated polydimethylsiloxane having an average molecular weight of 1000 g/mol (prepared by anionic polymerization of D3 cycles and termination with acetic acid) were reacted at room temperature with 67.7 g of (1-aminomethyl)dimethoxymethylsilane. ¹H NMR and ²⁹Si NMR showed that, after 30 minutes, all alkoxy groups had been reacted and an aminomethyl-functionalized polydimethylsiloxane having trimethylsilyl end groups had been obtained. The methanol by-product was removed under reduced pressure and 1040 g of poly(aminomethylmethylsiloxane-co-dimethylsiloxane) having a viscosity of 58 mPas were obtained.

### EXAMPLE 11

1000 g of monohydroxy-terminated polydimethylsiloxane having an average molecular weight of 1000 g/mol (prepared by anionic polymerization of D3 cycles and termination with acetic acid) were reacted at room temperature with 75.7 g of (1-aminomethyl)frimethoxysilane. ¹H NMR and ²⁹Si NMR showed that, after 30 minutes, all alkoxy groups had been reacted and a branched aminomethyl-functionalized polydimethylsiloxane having trimethylsilyl end groups had been obtained. The methanol by-product was removed under reduced pressure and 1040 g of poly(aminomethylmethylsiloxane-co-dimethylsiloxane) having a viscosity of 69 mPas were obtained.

### EXAMPLE 12

1000 g of bishydroxy-terminated polymethylvinyl-co-polydimethylsiloxane having a vinyl:methyl ratio of 1:4 and an average molecular weight of 2500 g/mol were reacted at room temperature with 27.2 g of (1-aminomethyl)dimethoxymethylsilane. ¹H NMR and ²⁹Si NMR showed that, after 30 minutes, all alkoxy groups had been reacted and an aminomethyl-functionalized polydimethylsiloxane having Si—OH end groups had been obtained. The methanol by-product was removed under reduced pressure and 990 g of poly(aminomethylmethylsiloxane-co-dimethylsiloxane-co-methylvinylsiloxane) having a viscosity of 130 mPas were obtained.

### EXAMPLE 13

100 g of bishydroxy-terminated polymethyltrifluoropropylsiloxane having a trifluoropropyl:methyl ratio of 1:1 and an average molecular weight of 900 g/mol were reacted at room temperature with 7.6 g of (1-aminomethyl)dimethoxymethylsilane. ¹H NMR and ²⁹Si NMR showed that, after 30 minutes, all alkoxy groups had been reacted and an aminomethyl-functionalized polydimethylsiloxane having Si—OH end groups had been obtained. The methanol by-product was removed under reduced pressure and 103 g of poly(aminomethylmethylsiloxane-co-trifluoropropylmethylsiloxane) having a viscosity of 53 mPas were obtained.

### EXAMPLE 14

1000 g of bishydroxy-terminated polydimethylsiloxane having an average molecular weight of 3000 g/mol were reacted at room temperature with 27.2 g of (1-aminomethyl)diethoxymethylsilane. ¹H NMR and ²⁹Si NMR showed that, after 90 minutes, all alkoxy groups had been reacted and an aminomethyl-functionalized polydimethylsiloxane having Si—OH end groups had been obtained. The ethanol by-product was removed under reduced pressure and 1010 g of poly(aminomethylmethylsiloxane-co-dimethylsiloxane) having a viscosity of 125 mPas were obtained.

### EXAMPLE 15

1000 g of bishydroxy-terminated polydimethylsiloxane having an average molecular weight of 3000 g/mol were reacted at room temperature with 36.9 g of 1,5-dimethoxy-1,1,5,5-tetramethyl-1,5-disila-3-azapentane. ¹H NMR and ²⁹Si NMR showed that, after 90 minutes, all alkoxy groups had been reacted and an aminodimethyl-functionalized polydimethylsiloxane having Si—OH end groups had been obtained. The methanol by-product was removed under reduced pressure and 1010 g of an aminodimethyl-functionalized polydimethylsiloxane having a viscosity of 137 mPas were obtained.

1-9. (canceled)

10. An amino-functional organosiloxane of formula I
(SiO_{4/2})ₖ(RSiO_{3/2})ₘ(R₂SiO_{2/2})ₚ(R₃SiO_{1/2})_{q}(O_{1/2}H)ₜ[(O_{f/2}R¹_{3-f}SiCR²₂)_{3-g}NR_{g}⁴]ₛ (I)
in which
R each, independently, is hydrogen or a monovalent Si—C-bonded C₁-C₂₀-hydrocarbon radical or C₁-C₁₅-hydrocarbonoxy radical, each of which is optionally substituted by —CN, —NCO, —NR^{x}₂, —COOH, —COOR^{x}, -halogen, -acryloyl, -epoxy, —SH, —OH or —CONR^{x}₂, and in each of which one or more non-adjacent methylene units may be replaced by —O—, —CO—, —COO—, —OCO—, —OCOO—, —S—, or —NR^{x}— groups, and in each of which one or more non-adjacent methine units may be replaced by —N═, —N═N— or —P═ groups,
R¹ each, independently is hydrogen or a monovalent Si—C-bonded C₁-C₂₀-hydrocarbon radical or C₁-C₁₅-hydrocarbonoxy radical which is optionally substituted by —CN, —NCO, —COOH, —COOR^{x}, -halogen, -acryloyl, —SH, —OH or —CONR^{x}₂, and in each of which one or more non-adjacent methylene units may be replaced by —O—, —CO—, —COO—, —OCO—, —OCOO—, —S—, or —NR^{x}— groups, and in each of which one or more non-adjacent methine units may be replaced by —N═, —N═N— or —P═ groups,
R^{x} each, independently, is hydrogen or a C₁-C₁₀-hydrocarbon radical optionally substituted by —CN or halogen,
R² each, independently, is hydrogen or a C₁-C₂₀-hydrocarbon radical optionally substituted by —CN or halogen,
R⁴ each, independently, is hydrogen or a C₁-C₂₀-hydrocarbon radical optionally substituted by —CN or halogen,
k, m, p, q are each, independently, an integer from 0 to 100,000,
f is an integer of 1, 2 or 3,
g is an integer of 0, 1 or 2,
s is an integer of at least 1 and
t is 0 or a positive integer, where the sum of
k+m+p+q is at least 1, and the amino-functional organosiloxane contains at least one pendent aminomethylene group.

11. The amino-functional organosiloxane of claim 10, wherein R is a C₁-C₁₀-alkyl radical or phenyl radical.

12. The amino-functional organosiloxane of claim 10, wherein R¹ is a C₁-C₆-alkyl radical.

13. The amino-functional organosiloxane of claim 11, wherein R¹ is a C₁-C₆-alkyl radical.

14. The amino-functional organosiloxane of claim 10, wherein R² is a C₁-C₃-alkyl radical or hydrogen.

15. The amino-functional organosiloxane of claim 11, wherein R² is a C₁-C₃-alkyl radical or hydrogen.

16. The amino-functional organosiloxane of claim 12, wherein R² is a C₁-C₃-alkyl radical or hydrogen.

17. The amino-functional organosiloxane of claim 10, wherein each R⁴ independently is a C₁-C₁₂-alkyl or aryl radical or hydrogen.

18. The amino-functional organosiloxane of claim 11, wherein each R⁴ independently is a C₁-C₁₂-alkyl or aryl radical or hydrogen.

19. The amino-functional organosiloxane of claim 12, wherein each R⁴ independently is a C₁-C₁₂-alkyl or aryl radical or hydrogen.

20. The amino-functional organosiloxane of claim 14, wherein each R⁴ independently is a C₁-C₁₂-alkyl or aryl radical or hydrogen.

21. The amino-functional organosiloxane of claim 10, wherein p has a value of from 3 to 1000.

22. The amino-functional organosiloxane of claim 10, wherein the sum k+m is 0.

23. The amino-functional organosiloxane of claim 10, wherein the sum k+m+p+q is at least 2.

24. A process for preparing an amino-functional organosiloxane of formula I of claim 10, comprising reacting siloxanes of formula (II)
(SiO_{4/2})ₖ(RSiO_{3/2})ₘ(R₂SiO_{2/2})ₚ(R₃SiO_{1/2})_{q}(O_{1/2}H)ᵣ (II),
with amino-functional silanes of formula (III)
[(R³O)_{f}R¹_{3-f}SiCR²₂]_{3-g}NR_{g}⁴ (III),
where
R³ is hydrogen or a C₁-C₂₀-hydrocarbon radical which is optionally substituted by —CN or halogen,
r is an integer of at least 1 and
t is less than r.

25. The process of claim 24 wherein at least one siloxane of the formula II is an α,ω-bis(hydroxy)-terminated disiloxane or polysiloxane, and at least one aminosilane of formula (III) is an optionaly N-substituted aminomethyl dialkoxy or trialkoxy silane.
